(19) United States
(12) Patent Application Publication
(10) Pub. No.: US 2003/0121391 A1
(43) Pub. Date: Jul. 3, 2003

(54) Disk-shaped tool, in particular, a circular saw blade

(76) Inventor: Albert Knebel, Balingen (DE)

Correspondence Address: STRIKER, STRIKER & STENBY, 103 East Neck Road, Huntington, NY, 11743, US

(21) Appl. No.: 10/308,617

(22) Filed: Dec. 3, 2002

(30) Foreign Application Priority Data
Dec. 28, 2001 (DE) 201 21 039.8

(51) Int. Cl. B27B 33/02

(52) U.S. Cl. 83/847; 83/846

(57) ABSTRACT

A disk-shaped tool, in particular, a circular saw blade, includes cutting teeth (11, 12, 13), in which the cutting teeth (12, 13, 14) are divided into groups (11). Each first tooth (12) of a group (11), in the cutting direction (15), protrudes radially farther outward with its cutting edge than the following tooth or teeth (13, 14) of the group (11).

### BACKGROUND OF THE INVENTION

The present invention relates to a disk-shaped tool, in particular, a circular saw blade with cutting teeth arranged about its circumference.

With sawing, in particular, of strong cutting materials such as chip-boards, the problem exists of moving out the existing saw dust as quickly as possible from the cutting area, in order to prevent a jamming of the saw blade in the work piece and/or an unfavorable cutting result.

For resolving this problem, circular saw blades with so-called spaced cutting edges, which are arranged laterally on the saw blade, were proposed. Also, by means of a specialized form of the cutting edges, attempts were made to improve the chip discharge. With all known saw blades, however, the cutting teeth are all uniformly shaped, so that upon engagement of each cutting tooth into the work piece, the same amount of cuttings or chippings results anew as with the preceding tooth.

The present invention addresses the underlying problem of providing a circular saw blade which allows a sufficient chip discharge, also upon machining of difficult to cut work pieces.

### SUMMARY OF THE INVENTION

The problem is resolved with a disk-shaped tool, in particular, a circular saw blade, with cutting teeth arranged about its circumference, according to the present invention, in which the cutting teeth are subdivided into groups, whereby, respectively, each first tooth of a group protrudes farther outward with its cutting edge than the following tooth or teeth of the group.

The first cutting teeth of a group are those cutting teeth that machine the work piece by chipping or cutting. The lower, following teeth serves in a first line for removing the existing chips and the cutting finish. It has been shown that by means of this grouped arrangement of the cutting teeth, much better cutting results can be achieved than with circular saw blades with uniform cutting teeth. In this manner, preferably three or more cutting teeth can be disposed in a group. The opposite distance of the cutting forming the first cutting teeth of the group is then large enough that the following teeth can removed the cuttings therebetween.

Particularly favorable results can be achieved when the first cutting tooth of a group protrudes outward radially past the following cutting tooth or teeth by from 0.3 to 0.8 mm. With groups with multiple following teeth, all of these teeth can protrude outwardly radially equally far or variously far.

For the cutting shape of the cutting teeth, various shapes are contemplated. With a preferred form of the present invention, the fist cutting tooth of a group has a cutting edge that is trapezoidal in longitudinal section, with lateral chamfers, whereby the chamfers can form an angle of 30° to 60° with the disk plane of the tool. The respective angle of the chamfers and height of the cutting can amount to between ¼ and ¾ of the cutting width of the tooth.

The cutting edges of the following tooth or teeth likewise can be provided on one or both sides with chamfers. Also, the chamfers of the following teeth can form an angle of 30° to 60° with the disk plane of the tool. In order to make possible an optimal removal of the cuttings, however, the width of the chamfers should be selected to be smaller than that of the first cutting teeth. Preferably, the width of the chamfers can be 1/25 to ⅕ of the cutting width of the tool. It is also possible, however, to use following teeth without chamfers.

For the rake angle, the rear clearance angle, and the tangential angle of the cutting teeth, conventional angular specifications can be selected. For example, the rake angle of all the cutting teeth can be between 5° and 30°. The rear clearance angle can be between 10° and 20°. For the tangential angle of the cutting teeth, a value of between 10 and 7° is preferred. In addition, the cutting teeth can have a radial angle of 0° to 3°.

### BRIEF DESCRIPTION OF THE DRAWINGS

FIG. 1 shows a cutaway portion of a circular saw blade;

FIGS. 2a, 2b, and 2c show a view from in front of the cutting teeth of the circular saw blade of FIG. 1;

FIGS. 3a and 3b shows a front view of a second embodiment of following teeth;

FIGS. 4a and 4b show a front view of a third embodiment of following teeth; and

FIGS. 5a, 5b, and 5c show various view of cutting teeth and their rake, rear clearance, tangential, and radial angles.

### DETAILED DESCRIPTION OF THE PREFERRED EMBODIMENTS

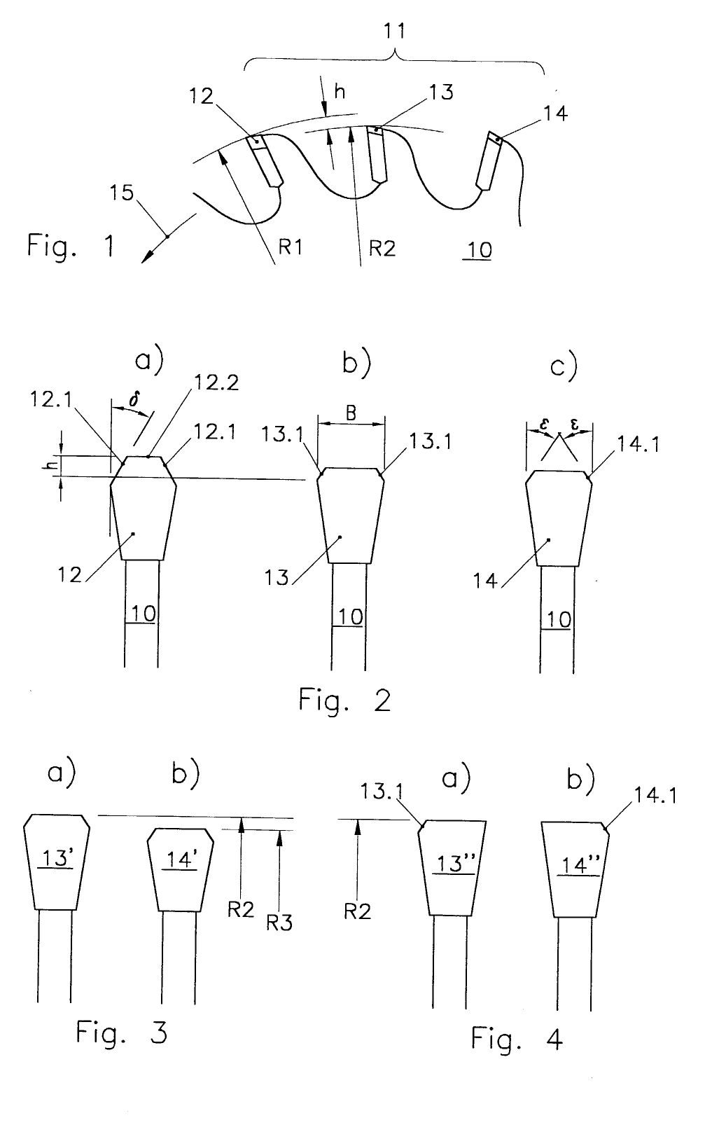

The cutaway portion of a saw blade 10 shown in FIG. 1 has a group 11 of three cutting teeth 12, 13, 14. The first cutting tooth 12, in the cutting direction 15 of the saw blade 10, projects at a distance h radially over the tooth following teeth 13, 14. In this manner, also the outer radius R1, which is defined by the first cutting tooth 12, at h is greater than the radius R2, which is defined by the cutting edges of the following teeth 13, 14.

As the front view of the teeth 12, 13, 14 in FIGS. 2a through 2c show, the cutting edge shape of the first teeth 12 is trapezoidal with two lateral chamfers 12.1. The chamfers 12.1 form an angle δ of 30° to 60° with the disk plane of the tool 10. The remaining straight cutting area 12.2, then, is between ¼ and ¾ of the entire cutting width B of the circulate blade 10 (FIG. 2b).

As shown in FIGS. 2b and 2c, both following teeth 13, 14 are identically formed. Also, they have lateral chamfers 13.1, 14.1, which likewise form an angle ε of between 30° and 60° with the plane of the circulate saw blade 10. The cutting teeth 13, 14, however, are shorter at the value h than the cutting teeth 12. In this connection, the width of the chamfers 13.1, 14.1 are approximately 1/25 to ⅕ of the entire width B of the circular saw blade 10.

The alternative embodiment possibilities 13′, 14′, or 13″, 14″, of the following teeth 13, 14 are shown in FIGS. 3 and 4. In contrast to the teeth 13, 14, the teeth 13′, 14′ according to FIG. 3 are of a different length. Here, the tooth 13′ protrudes compared to the tooth 14′ radially outward.

With the embodiment according to FIG. 4, the teeth 13″, 14″ again are the same length, but here, each have a chamfer 13.1 or 14.1 on only one side. Of course, an embodiment of the following teeth 13, 14 completely without chamfers 13.1, 14.1 is also possible.

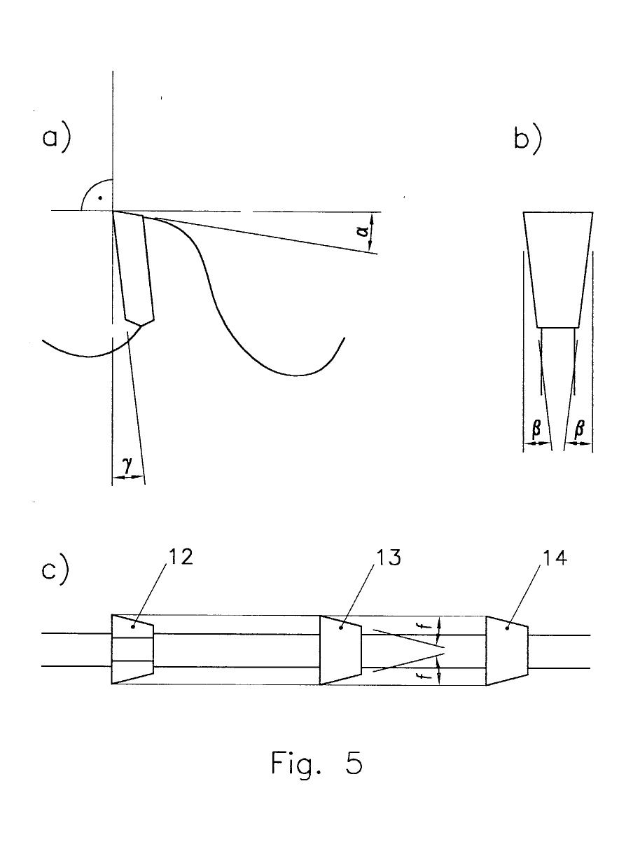

All cutting teeth 12, 13, 14, 13′, 14′, 13″, 14″ in addition have the rake angle γ shown in FIG. 4 of between 5° and 30°, a rear clearance angle α of between 10° and 20° (FIG. 5a), a radial angle β of between 0° and 3° (FIG. 5b), and a tangential angle f of between 1° and 7° (FIG. 5c).

It will be understood that each of the elements described above, or two or more together, may also find a useful application in other types of constructions differing from the types described above.

While the invention has been illustrated and described herein as a disk-shaped tool, in particular, a circular saw blade, with cutting teeth, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A disk-shaped tool, in particular, a circular saw blade, with cutting teeth (11, 12, 13; 13′, 14′; 13″, 14″), characterized in that the cutting teeth (12, 13, 14; 13′, 14′; 13″, 14″) are divided into groups (11), and each first tooth (12) of a group (11), in the cutting direction (15), protrudes radially farther outward with its cutting edge than the following tooth or teeth (13, 14; 13′, 14′; 13″, 14″) of the group (11).

2. The tool of claim 1, characterized in that a group (11) of preferably three or more cutting teeth (12, 13, 14) is formed.

3. The tool of claim 1, characterized in that the first cutting tooth (12) of a group protrudes outward radially past the following cutting tooth or teeth (13, 14; 13′, 14′; 13″, 14″) by 0.3 to 0.8 mm.

4. The tool of claim 1, characterized in that in groups (11) having a plurality of following teeth (13, 14; 13′, 14′; 13″, 14″), the following teeth (13, 14; 13″, 14″) all protrude radially outward equally far or variously far.

5. The tool of claim 1, characterized in that a first cutting tooth (12) of a group (11) has a cutting edge that is trapezoidal in longitudinal section, with lateral chamfers (12.1).

6. The tool of claim 5, characterized in that the chamfers (12.1) form an angle (δ) of 30° to 60° with the disk plane of the tool (10).

7. The tool of claim 5, characterized in that a width of the chamfers (12.1) is between ¼ and ¾ of a cutting width (B) of the tool (10).

8. The tool of claim 1, characterized in that the cuffing edges of the following tooth or teeth (13, 14; 13′, 14′; 13″, 14″) are provided on one or both sides with chamfers (13.1, 14.1).

9. The tool of claim 8, characterized in that the chamfers (13.1, 14.1) of the following teeth (13, 14; 13′, 14′; 13″, 14″) form an angle (ε) of 30° to 60° with the disk plane of the tool (10).

10. The tool of claim 8, characterized in that a width of the chamfers (13.1, 14.1) on the cutting edges of the following teeth (13, 14; 13′, 14′; 13″, 14″) is between 1/25 and ⅕ of a cutting width (B) of the tool (10).

11. The tool of claim 1, characterized in that all of the cutting teeth (12, 13, 14; 13′, 14′; 13″, 14″) have a rake angle (y) of 5° to 30°.

12. The tool of claim 1, characterized in that all of the cutting teeth (12, 13, 14; 13′, 14′; 13″, 14″) have a rear clearance angle (α) of 10° to 20°.

13. The tool of claim 1, characterized in that all of the cutting teeth (12, 13, 14; 13′, 14′; 13″, 14″) have a tangential angle (f) of 1° to 7°.

14. The tool of claim 1, characterized in that all of the cutting teeth (12, 13, 14; 13′, 14′; 13″, 14″) have a radial angle (β) of 0° to 3°.
